(19) United States
(12) Patent Application Publication
(10) Pub. No.: US 2013/0315595 A1
(43) Pub. Date: Nov. 28, 2013

(54) TIME DIVISION DUPLEXING FOR EPoC

(71) Applicant: ENTROPIC COMMUNICATIONS, INC., San Diego, CA (US)

(72) Inventor: David Barr, San Jose, CA (US)

(73) Assignee: Entropic Communications, Inc., San Diego, CA (US)

(21) Appl. No.: 13/890,115

(22) Filed: May 8, 2013

Related U.S. Application Data
(60) Provisional application No. 61/650,855, filed on May 23, 2012.

(51) Int. Cl. H04J 14/08

(52) U.S. Cl. CPC H04J 14/08
USPC 398/67

(57) ABSTRACT

A method, system and computer program for implementing TDD in an EPoC network. An OLT or CLT scheduler segregates the US traffic from the DS traffic to avoid collisions. An OLT transmits and receives payloads through an OCU. An OLT or CLT transmits downstream payloads and GATE grants destined for CNUs during the TDD downstream phases. The OLT or CLT schedules IPGs between TDD phases. The OLT or CLT schedules payloads and REPORTs to be transmitted from CNUs only during the TDD upstream phase according to the GATE grants in the DS phase. The OLT or CLT receives CNU REPORTs late in the upstream phase that inform the scheduler about pending upstream traffic to be granted in subsequent TDD phases.

### RELATED APPLICATIONS

This application claims the benefit of U.S. Provisional Application No. 61/650,855, filed May 23, 2012, the specification of which is incorporated herein by reference.

### FIELD

This disclosure is related to a communication system and more particularly to extending Ethernet Passive Optical Networks (EPON) Protocol over Coax based access networks.

### BACKGROUND INFORMATION

### EPON

EPON is an IEEE 802.3 protocol specification enabling Ethernet Passive Optical Networks. Passive Optical Networks (PONs) use an Optical Distribution Network (ODN) generally using passive fiber-optic cables and passive optical splitters forming a point-to-multipoint topology. EPON is often deployed by Operator/Service Providers (OSPs) as an Access Network, to provide high-speed access to the internet backbone and Business Services to medium-to-large businesses seeking strict Quality of Service (QoS) Service Level Agreement (SLA) contracts including low-latency, low-jitter, and guaranteed throughput. Typically there is an Optical Line Terminal (OLT) at the headend (e.g., located in an OSP's central office site), and there is an Optical Network Unit (ONU) at each of one or more Customer Premise Equipment (CPE) endpoint sites. The service group for an EPON OLT often comprises up to 16˜32 ONUs. The headend OLT can send messages Downstream (DS) over the ODN point-to-multipoint, and the ONUs at the CPE endpoints can send messages to the OLT multipoint-to-point over the ODN. The OLT produces downstream messages in the form of serial binary bitstreams that are converted to optical signals (e.g., OOK On-Off-Keying pulses produced by so-called ‘digital’ laser) onto a fiber-optic cable and into the ODN to reach each ONU at the CPE endpoints. The ODN generally comprises passive optical components, so substantially the same optical signals reach all of the ONUs. However, due to ODN topology (e.g., lengths of fiber and location of splitters), there are generally differences in propagation times among all the branches in the ODN, often resulting in differing arrival times and differing arrival amplitudes of the optical signal among all the ONUs.

The OLT produces the downstream serial bitstream at some constant EPON data-rate, such as 1 Gbps or 10 Gbps. If there are no messages to send downstream, then the OLT will transmit IDLE characters between data traffic. Thus, EPON downstream traffic is a continuous bitstream at some constant EPON data-rate.

Upstream (US) transmissions are formed by ONUs as a serial binary bitstream, but are generally not continuous, so upstream traffic from a plurality of ONUs is coordinated by the OLT in order to ensure that non-continuous so-called burst transmissions from various ONUs do not collide (overlap in time) and that the OLT will observe an orderly sequential arrival of burst transmissions from different ONUs in a predictable order and at predictable times (within some tolerance of time-jitter). This approach is often called TDMA time-division multiple access.

There are three versions of EPON currently specified:
a) 1 Gbps symmetric (formerly amendment 802.3ah);
b) 10 Gbps symmetric (amendment 802.3av-2009);
c) Asymmetric 1 Gbps upstream, 10 Gbps downstream (802.3av-2009).

Upstream (US) traffic generally uses the same wavelength for both 1 Gbps and 10 Gbps data-rates. Downstream (DS) traffic generally uses different optical wavelengths for 1 Gbps and 10 Gbps data-rates. It can be deduced that there is interest in supporting both symmetric and asymmetric upstream/downstream data-rates.

Since EPON's upstream traffic and downstream traffic use different wavelengths, bitstreams can be transmitted over the ODN in both directions simultaneously and independently (i.e., full duplex). This particular duplexing strategy is called wavelength division duplex (WDD), or more generally, Frequency Division Duplex (FDD). The OLT has exclusive use and access to the downstream wavelength(s), and the OLT can coordinate/schedule use of the upstream wavelength independently from the downstream.

OLTs use EPON's Multipoint Control Protocol (MPCP) to coordinate/schedule the TDMA upstream bursts. The MPCP protocol relies on constant Round-Trip Time (RTT) as observed/measured by the OLT. The OLT may measure a different RTT for each ONU, but that RTT must remain more or less constant (within some tolerance). MPCP messages include timestamps to facilitate OLT's measurement of RTT. Each ONU maintains its own MPCP Clock by setting its clock counter value to that of the OLT's timestamp embedded in downstream MPCP messages received from the OLT. Since fibers to each ONU may have varying length, the MPCP Clocks among different ONUs are not necessarily synchronized. The RTT comprises a downstream trip plus an upstream trip, which may be different (e.g., different wavelengths may propagate at different velocities on a fiber). The OLT will observe/measure RTTs, but may also know (e.g., be configured for) or assume some fractional split (e.g., 50%: 50%) of the RTT into separate downstream and upstream link delays.

ONUs hold traffic destined for the OLT in various queues often associated with particular Service Flows (e.g., an ordered sequence of Ethernet Frames with similar classification), and identified by Logical Link Identifiers (LLIDs) assigned by the OLT. ONUs report the status (e.g., fullness) of their various upstream queues in the form of a MPCP REPORT message. The OLT receives such REPORTs from the ONUs, then the OLT's MAC Control Client (aka Scheduler) schedules upstream traffic from the various queues of various ONUs, then issues TDMA grants to particular ONUs in the form of MPCP GATE messages. All upstream traffic is scheduled/granted in this fashion: even REPORT messages must be granted via a GATE message in the downstream. GATE messages grant a startTime and a length. When an ONU's MPCP Clock reaches the GATE-specified startTime, the ONU transmits upstream at the constant EPON data-rate, from the GATE-specified LLID queue, and for a duration equal to the GATE-specified length. The GATE-specified grant yields an upstream transmission of some integer number of Layer 2 payload bytes (the exact number of bytes is known to both ONU transmitter and OLT receiver), which usually corresponds to some integer number of variably-sized Ethernet Frames.

The OLT's scheduler arranges the grants, ensuring the OLT will observe an orderly sequential arrival of burst transmissions from a plurality of ONUs, arriving in a predictable order and at predictable times (within some tolerance of time-jitter). The OLT's scheduler understands that grants will depend on the RTT for each particular ONU. For example, the OLT could transmit downstream two GATE messages with identical startTime and identical short grant length, destined for two different ONUs, one with 1 km effective fiber length, and the other with 20 km effective fiber length; understanding that the consequent upstream transmissions will not overlap/collide with each other, due to their differing RTTs (i.e., the upstream transmission from the more distant ONU will arrive after that from the nearby ONU).

In summary, EPON protocols were designed around assumptions based on FDD simultaneous US and DS optical fiber transmission:
a) serial bitstream emissions from Layer 2 submitted into Layer 1 of a transmitting device;
b) serial bitstream undergoing constant processing delay through Layer 1 of the transmitter (Tx);
c) serial bitstream undergoing constant propagation delay through the ODN;
d) serial bitstream undergoing constant processing delay through Layer 1 of a receiving device;
e) received serial bitstream being submitted to Layer 2 of a receiver (Rx);
f) resulting in a constant US link delay for a given serial bit, from ONU Tx Layer 2 to OLT Rx Layer 2;
g) resulting in a constant DS link delay for a given serial bit, from OLT Tx Layer 2 to ONU Rx Layer 2;
h) US+DS link delays summing to a constant RTT, bit-for-bit, as observed/measured by the OLT.

There are other PON specifications, such as APON, BPON, and GPON, which share many of the same characteristics as EPON so this disclosure applies to them as well.

### HFC Access Networks

A publicly-available overview of hybrid fiber and coaxial (HFC) Cable Systems (e.g., slides 5 & 6) can be found at:http://www.ieee802.org/3/epoc/public/mar12/schmitt_{—}01_{—}0312.pdf. HFC Cable Access Networks are typically deployed by multiple system operators (MSOs), which are OSPs that operate multiple HFC cable systems. They are used to provide subscribers access to a variety of services, such as pay television (TV), video on demand (VoD), voice over internet protocol (VoIP) telephony, residential cable modem internet service, and small-medium business (SMB) Business Class Internet service. These various services have been designed, and the plants engineered, to support simultaneous coexistence on the shared HFC medium. The point-to-multipoint topology deployed varies according to the size and footprint of the service group of CPEs, and how distant they may be from the headend (or Hub). For example, in China, the service group is often a multiple dwelling unit (MDU) with dense concentration of the CPEs in the service group, and relatively short distance to the headend often located in the basement (e.g., Fiber-to-the-Basement (FTTB)). For example, in North America, the service group may be larger and more dispersed (e.g., spanning suburban neighborhoods), and the headend might be remotely located (e.g., tens of miles away).

CPE endpoints are connected via coax (coaxial cable), and the coax plant is driven by one or more radio frequency (RF) amplifiers, passing a variety of modulation techniques depending on the particular service and its assigned spectral occupation in the RF band (typically within 5˜1002 MHz). Smaller plants can be serviced by coax alone, so the headend can interface the coax plant directly. Remote headends can drive the HFC via fiber, with Fiber Nodes deployed at various locations in the middle of the network to convert to/from fiber and coax. These ‘analog’ fiber plants in HFC networks are typically driven by ‘analog’ lasers, modulating the amplitude of the optical signal in direct correspondence to an RF signal waveform (i.e., amplitude modulation (AM)). Fiber Nodes perform a relatively direct media conversion:
a) DS: from RF-modulated optical signal on fiber to RF electrical signal on coax to the CPEs;
b) US: from RF electrical signal on coax to RF-modulated optical signal on fiber to the headend;
   where imperfect optical-to-electrical (OE) and electrical-to-optical (EO) conversions, along with AM transmission over fiber, contributes impairments to the RF signal fidelity (e.g., degradation of signal-to-noise ratio (SNR)).

The topology of the coax plant is a cascade of various active and passive components, such as amplifiers, rigid trunk-line coax, feeder-line coax, multitaps, drop-line coax (to individual customer premises), and RF splitters. Cascade lengths vary from:
0) ‘Node+0’ cascades: with zero active components (e.g., no in-line amplifiers) after the Fiber Node (if any), meaning the coax plant contains only passive elements (e.g., taps or splitters). Node+0 plants are quite common in China. They are less common among North America MSOs, but remain a goal for the future evolution of their HFCs.
1) Node+1: with one active amplifier after the Fiber Node (if any);
2) Node+2: with two active amplifiers after the Fiber node (if any);
3) Node+N: with N amplifiers (e.g., Node+5 cascades are common among North American MSOs' HFCs).

Many HFC plants have been deployed with FDD operation within certain frequency bands, using diplex filters installed throughout the HFC infrastructure (e.g., within various RF amplifiers). This FDD infrastructure was often deployed decades ago, before the advent of widespread internet use, and MSOs now find their existing split locations to restrict future use cases. In particular, MSOs are studying the possibility of moving the split location to allocate additional spectrum for the upstream channel. Moving the split is an expensive and labor-intensive upgrade that may require thousands of truckrolls to deploy (and with consequent service disruptions), so MSOs try to anticipate the evolution of future usage. Predicting the future presents its own risks if the MSOs guess wrong, but this is the predicament that MSOs find themselves in having FDD HFCs already deployed.

The coax plants of HFC networks in North America are often operated as FDD within US spectral allocations (typically 5˜42 MHz) and DS spectral allocations (typically from 54 MHz up to 750, 860 or 1002 MHz as examples), with an allowance for a so-called ‘Split’ or guard band (typically 42-54 MHz) where FDD diplexing filters are used to isolate the simultaneous US & DS transmissions from each other. Coax plants of HFC networks outside North America might be operated with a different FDD split location in the spectrum. An example of an FDD service: data over cable system interface specification (DOCSIS) cable modem service may occupy one or more single-carrier ‘QAM’ channels occupying 6 MHz of spectrum in the DS band, and one or more QAM channels in the US band. DOCSIS headend equipment is known as a cable modem termination system (CMTS). DOCSIS CPEs include Cable Modems, Residential Gateways and Set-Top Boxes.

As subscribers consume more and more throughput capacity in both upstream and downstream directions, MSOs have lashed more and more fiber overlaying the existing coax infrastructure in order to locate additional Fiber Nodes deeper into the cascade. This has the effect of segmenting the cascade, thereby reducing the service group size such that each subscriber competes with fewer neighbors for shared coax resources, resulting in greater throughput capacity available to CPEs. DOCSIS revisions, such as version 3.1, continue to improve capacity to address the seemingly inevitable migration to ‘All-IP’ (Internet Protocol packetized) delivery, including video.

EPoC: EPON Protocol over Coax

MSOs currently must deploy fiber to the premises to support EPON for high-end Business Services subscribers. This often involves digging trenches or other significant cable-laying expenses, even if those customer premises are already passed by the coax plant of a MSO's HFC network. The MSO may already offer Business Class Internet (DOCSIS) services over the existing HFC plant, but some subscribers will require strict QoS performance (such as that described by the Metro Ethernet Forum specification MEF-23.1) SLAs that may require EPON to satisfy. Consequently, MSOs desire an invention that would reduce expenses by enabling deployment of EPON-class QoS to subscribers without having to deploy fiber to the premises, but instead utilizing the existing HFC plant, or the coax portion of the HFC plant. In addition, EPON OLTs are significantly less expensive than DOCSIS CMTSs, which can further reduce MSO expenses. Thus, EPoC represents a desire for MSOs to have a lower-cost option of using the existing HFC medium for EPON-like services.

MSOs also desire that EPoC devices be manageable in some similar way as they manage EPON (e.g., DPoE DOCSIS Provisioning of EPON specification from CableLabs). So, there is a desire to maintain most/all of EPON's layers and sublayers above Layer 1 PHYsical layer. Most particularly, the IEEE EPoC effort seeks to preserve unchanged EPON's Ethernet Medium Access Control (MAC) Sublayer within Layer 2, and to make only ‘minimal augmentation’ of other sublayers in Layer 2 (e.g., in the MPCP sublayer) and higher layers (such as Operations, Administration and Management (OAM)), by confining most of the new RF coax protocols to a Layer 1 PHY specification. MSOs believe that end-to-end management of EPoC devices will be easier to accomplish if a single EPON MAC domain can span from OLT to EPoC CPEs. Consequently, there is a desire to make operation of EPoC CPEs transparent to the OLT. Since EPON protocols were designed around an FDD medium, and because North American MSOs have already deployed FDD HFCs, EPoC intends to support FDD over coax.

### EPoC Architecture

EPoC CPEs, which connect directly to the coax plant 20, are called coax networking units (CNUs) 10, and are desired to resemble ONUs 12 at Layer 2 and above, as illustrated in FIGS. 1 and 2. An un-augmented or minimally augmented EPON OLT 14 connects to fiber plant 16 at the headend. In one embodiment, an optical-coax unit (OCU) 18, aka FCU fiber-coax unit can be located somewhere in the middle that performs bidirectional conversions from EPON's ‘digital’ fiber 16 to RF coax 20. OCU 18 and its conversions are desired to be transparent to OLT 14 so that the OLT can remain un-augmented or minimally augmented. In the presently claimed invention, an OCU may filter-out DS payloads (based on LLID or some other criteria) that are not intended for CNUs residing on the coax that the OCU services. In other words, the digital fiber may carry payloads intended for ONUs, or intended for CNUs belonging to some other OCU, and it is desirable for OCUs to filter-out these payloads out before relaying DS traffic onto the RF coax in order to avoid unnecessary traffic from consuming coax resources.

### SUMMARY

The presently claimed invention provides solutions to the problems raised above. EPoC specifically contemplates a new coax line terminal (CLT) 22 device that would resemble an OLT, but instead interface via RF signals, either to the ‘analog’ fiber 24 at the headend of an HFC, or directly to the headend of an all-coax plant, as shown in FIGS. 3 and 4.

Preserving the EPON MAC sublayer at both endpoints implies PHY-layer processing and transport of the serial bitstream with constant RTT, corresponding to the sum of the downstream and upstream link delays:
In the downstream, measured from emission by the CLT/OLT MAC sublayer, to submission to the EPON MAC sublayer in the CNU; and,
In the upstream: measured from emission by the EPON MAC sublayer in the CNU, to submission to the CLT/OLT MAC sublayer.

An FDD mode of operation for EPoC seems certain. In the FDD mode of operation, downstream traffic gets converted relatively directly by the OCU from WDD/FDD over digital fiber into FDD over RF coax. Such relatively direct conversion by the OCU is also known as Media Conversion (aka PHY-level Repeater), since there is little complication beyond straightforward conversion from fiber medium to coax medium. Similarly, upstream burst traffic from CNUs gets converted by the OCU from FDD on coax to WDD/FDD on digital fiber. In the FDD mode of operation, the OCU performs media conversions for both downstream and upstream traffic simultaneously, by using to two different RF channels over coax. Such PHY-layer Media Conversion can be accomplished with constant processing delay to satisfy EPON protocols' reliance on constant RTT.

However, many MSOs desire an additional TDD mode of operation for EPoC. Such a TDD mode seems quite challenging to specify because the EPON protocols that MSOs wish to preserve were specifically designed only for FDD's simultaneously available full-duplex US & DS channels. EPON protocols were not designed for alternative duplexing strategies, such as Time-Division Duplex (TDD), where a single wavelength or RF spectral channel-width would be used, alternating-in-time between upstream and downstream (half duplex). TDD's single half-duplex channel alternates between US and DS traffic, which implies the DS link would be unavailable during US traffic, and vice versa. Further complicating the challenge of TDD operation are EPON constraints outlined above such as maintaining constant RTT, and the desire to preserve unchanged the MAC sublayer.

Despite these severe challenges, MSOs nevertheless wish to consider such a mode due to TDD's increased flexibility (compared to FDD) for adapting to the evolution of future US and DS traffic patterns. One benefit of TDD is that the symmetry or asymmetry of the US and DS capacities is a relatively simple (and possibly realtime) adjustment of the duty-cycle phasing of the TDD Cycle. Use of TDD in the Access Network would have enabled a more flexible way for MSOs to easily, quickly and inexpensively adjust the relative throughput capacity of the upstream and downstream directions within a single spectral allocation, whereas FDD requires paired spectral allocations established by inflexible diplex filters distributed throughout the coax cascade. For a given total aggregate spectral allocation, TDD's single spectral allocation could be made as wide as the sum of FDD's paired allocations, enabling TDD's burst datarate capability in either direction being approximately double that of FDD in either direction (for symmetric US and DS FDD allocations). Use of TDD in the Access Network would have enabled fewer or no splits in some coax plants.

The following presents a simplified summary of one or more embodiments in order to provide a basic understanding of some aspects of such embodiments. This summary is not an extensive overview of the one or more embodiments, and is intended to neither identify key or critical elements of the embodiments nor delineate the scope of such embodiments. Its sole purpose is to present some concepts of the described embodiments in a simplified form as a prelude to the more detailed description that is presented later.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 is an illustration of an OLT to ONU fiber connection and an OCU conversion from a fiber to a coax for CNUs.

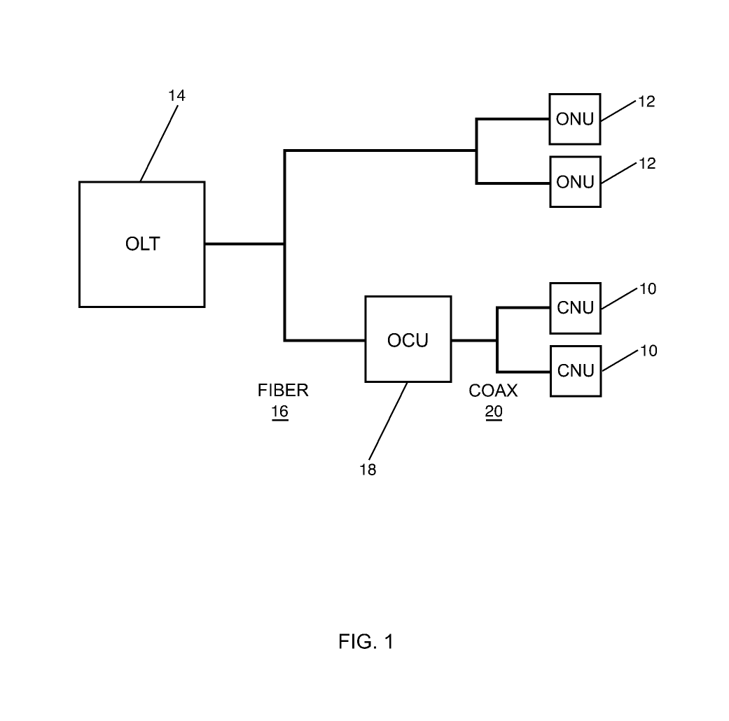

FIG. 2 illustrates the OCU conversion of FIG. 1.

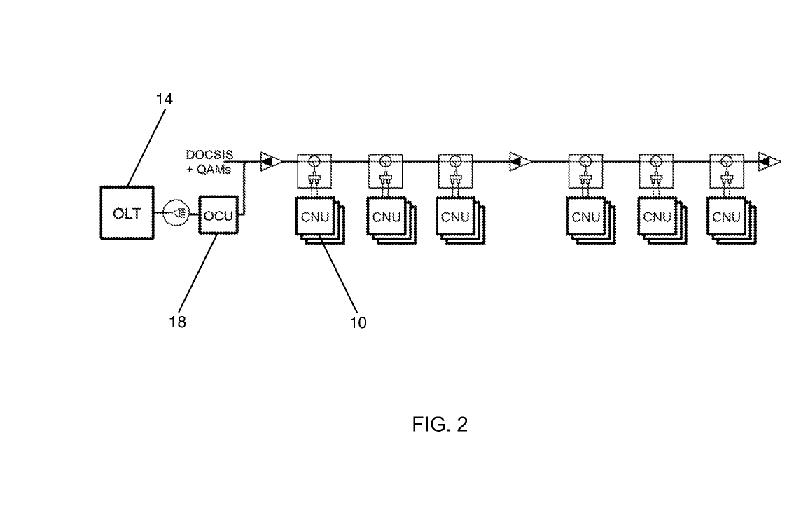

FIG. 3 illustrates a new CLT that resembles an OLT that interfaces to an analog fiber.

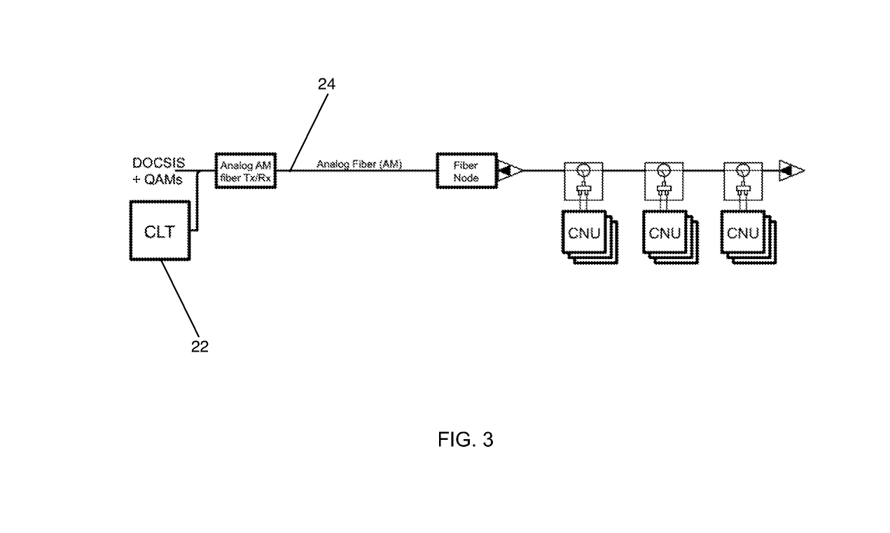

FIG. 4 illustrates a CLT that connects directly to a coax.

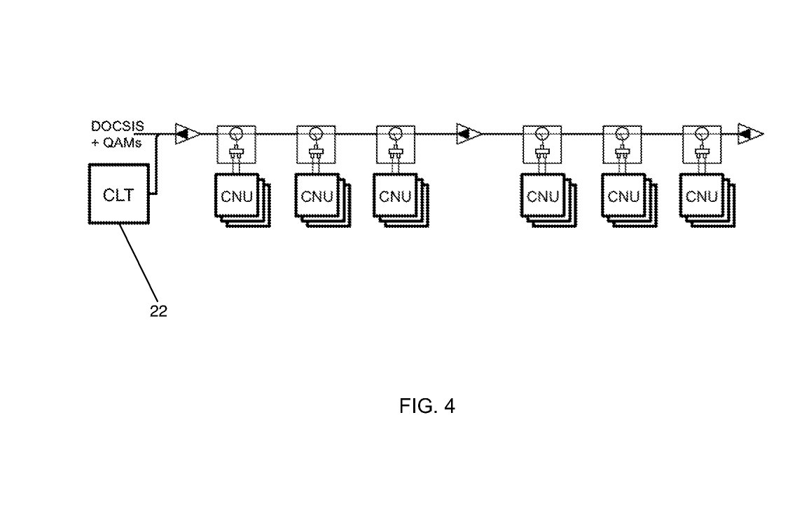

FIG. 5 illustrates two OCUs, each serving a passive coax segment.

FIG. 6 illustrates two OCUs each serving a passive coax segment on two different cascades.

FIG. 7 illustrates an example of the preferred embodiments.

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

In a preferred embodiment, there is a desire to reuse or reapply EPoC's development of a new FDD PHY-layer specification and leverage EPoC's FDD mode of operation towards an optional TDD mode of operation. This is problematic as explained above since OCU Media Conversion would need to include the complication of buffering in either direction to accommodate waiting for the duplexing phase to cycle between upstream and downstream directions. In a preferred embodiment, the OCU media converter used for FDD could be repurposed for a TDD mode of operation by tuning the upstream and downstream repeaters to share the same RF channel over coax (i.e., occupying a single spectral allocation in TDD, as opposed to two different spectral allocations in FDD). For example, the center frequency of the downstream coax channel could be made equal to the center frequency of the upstream coax channel (f_{downstream}=fᵤₚₛₜᵣₑₐₘ). This would otherwise result in traffic collisions on the coax segment, but in a preferred embodiment, the OLT scheduler would segregate upstream and downstream traffic on the coax segment. By aggregating downstream traffic together into periodic intervals, and aggregating upstream traffic into periodic intervals, then segregating and interleaving the periodic intervals such that US and DS traffic do not overlap in time, collisions can be avoided on the coax segment. Since the FDD repeater is substantially reused for the TDD mode of operation, its constant processing delay enables a constant RTT upon which EPON OLTs (and their MPCP protocol) rely. In this preferred embodiment, constant RTT allows EPON's full-duplex MAC sublayer to be preserved, as MSOs prefer. Another specific benefit of the claimed invention is substantially reusing EPoC's FDD PHY layer specification for the TDD mode of operation. Such reuse avoids the lengthy and expensive developments of an entirely new PHY-layer specification and subsequent chip-level PHY implementations.

The OLT scheduler can avoid collisions in the TDD mode of operation by segregating the upstream and downstream traffic phases with a time gap (aka inter-phase gap (IPG)) between TDD phases. An IPG may allow time for transmissions to complete their propagation from transmitter(s) to intended receiver(s), time for the medium to sufficiently quiesce (if necessary) after reception(s), and time for destination transceiver(s) to switch (if necessary) from receive to transmit mode.

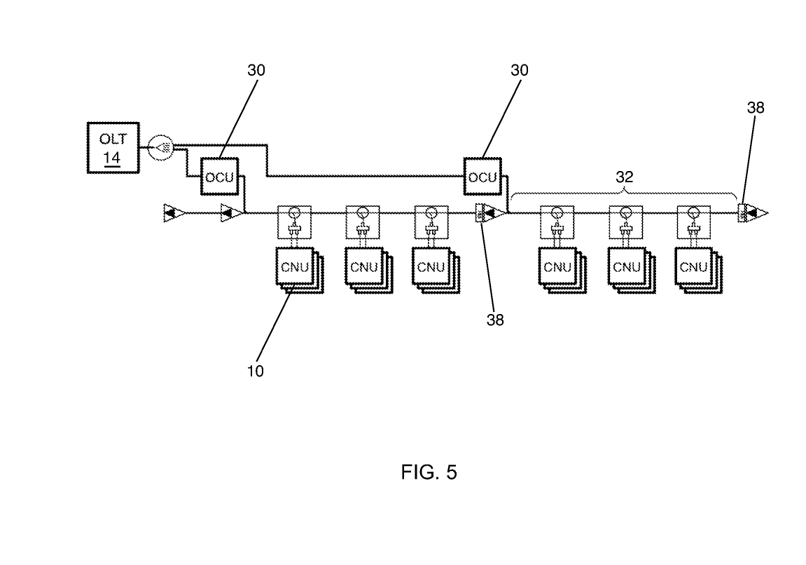

The IPG may be adapted for various TDD topologies, such as (but not limited by):
a) TDD domain spanning: digital fiber, OCU and HFC cascade (optionally including analog fiber);
b) TDD domain spanning an HFC cascade, optionally including analog fiber;
c) TDD domain spanning only a passive coax segment.
The OLT scheduler may arrange an IPG between the US and DS phases allowing time for upstream transmissions from CNU(s) to complete their propagation over coax, over analog fiber (if any), through an OCU, and over digital fiber to the OLT. Similarly, the OLT scheduler may also arrange an IPG between the DS and US phases allowing time for its downstream transmissions to propagate over digital fiber, through an OCU, over analog fiber (if any), and over coax to destination CNU(s). In this embodiment, overlap and collisions are avoided over the entire cascade including the digital fiber. This means the entire cascade can be operated as a single TDD domain. EPON's digital fiber is operated in WDD/FDD mode consuming two wavelengths simultaneously, but in this embodiment the digital fiber may be operated in TDD mode reusing a single optical wavelength for both US and DS transmissions over digital fiber. There can be some benefit to enabling a TDD mode of operation over digital fiber, made possible by including additional duration in the IPG to avoid overlap of US & DS transmissions over digital fiber. Besides reuse of a single optical wavelength, there could be other benefits such as enabling ONUs (not just CNUs) to operate in TDD mode. However, the additional IPG duration required to avoid overlap on digital fiber may have an adverse impact on the temporal efficiency of the TDD mode of operation. For example, increasing the IPG to allow for 20km of digital fiber would add about 100 μ of unscheduleable unusable channel-time between TDD phases.
In another embodiment, the OLT or CLT scheduler may arrange an IPG between the US and DS phases allowing time for upstream transmissions from CNU(s) to complete their propagation over coax, and over analog fiber (if any), to a CLT or OCU. Similarly, the scheduler may also arrange an IPG between the DS and US phases allowing time for its downstream transmissions to propagate from a CLT or OCU, over analog fiber (if any), then over coax to destination CNU(s). In this embodiment, overlap and collisions are avoided on the HFC, but additional IPG duration is required to accommodate the analog fiber into the TDD domain, thereby adversely affecting temporal efficiency of the TDD mode of operation.
In a preferred embodiment, as shown in FIG. 5, an OCU 30 or CLT would be installed near a passive coax segment 32. FIG. 5 shows two such OCUs 30, each servicing a passive coax segment 32 which, in this example, happen to be adjacent coax segments on an HFC cascade:

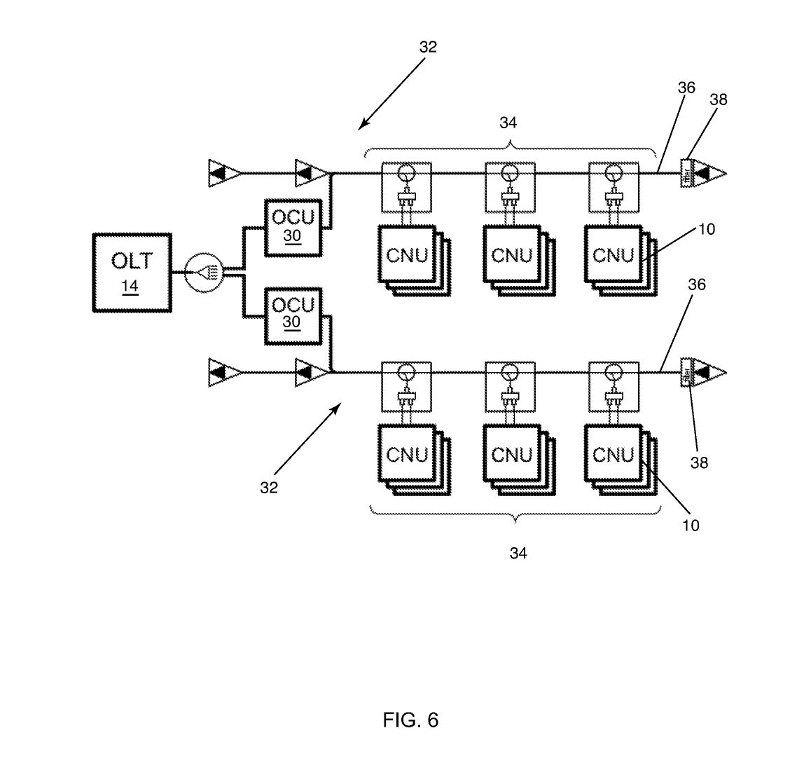

FIG. 6 shows another example depicting two such OCUs 30, each servicing a passive coax segment 32 on two different cascades 34.

MSOs may install digital fiber 36 overlaying their HFC cascade 34, extending to the OCU(s) 30 that inject RF signals onto passive coax segment(s) between actives. Digital fiber overlays 36 and OCU(s) 30 are not required to reach every passive coax segment, nor are they required to reach every last active to serve the last passive coax segment on a HFC cascade 34. Digital fiber overlays 36 and OCUs 30 are required only to reach those particular passive coax segments for which the MSO wishes to provide EPoC service to (e.g., Business Services) subscribers. Filter 38 may optionally be installed at the downstream end of a passive coax segments in order to filter out EPoC RF signals before the reach any downstream amplifier.

In a preferred embodiment, the OLT or CLT scheduler may arrange an IPG between the US and DS phases allowing time for upstream transmissions from CNU(s) to complete their propagation over a passive coax segment only, to the OCU or CLT. Similarly, the scheduler may also arrange an IPG between the DS and US phases allowing time for its downstream transmissions to propagate from the OCU or CLT, over passive coax, to destination CNU(s). The propagation times in this embodiment are relatively short, because passive coax segments are usually relatively short. The relatively short IPGs that result are highly desirable in TDD applications because these periods represent duplexing overhead when the channel is unavailable to carry traffic in either direction.

A specific benefit of the invention enables shorter IPG durations and higher temporal efficiency of TDD duplexing by confining the TDD domain to only the passive coax segment, i.e., US and DS transmissions are prevented from overlapping and colliding on coax, but the corresponding US and DS transmissions are allowed to overlap on digital fiber. These corresponding US and DS transmissions on digital fiber overlap, but do not collide, because the EPON digital fiber is operated as WDD/FDD, allowing US and DS transmissions to pass each other on fiber on different wavelengths without collision. In this embodiment, the OCU middle box interfaces the WDD/FDD digital fiber to the TDD passive coax segment. By confining the TDD domain to the passive coax segment, and allowing the digital fiber to carry simultaneous overlapping US and DS traffic via WDD/FDD, the claimed invention not only preserves the EPON full-duplex MAC sublayer, but actually leverages it to facilitate short IPG (whose duration is adapted only to the relatively short passive coax segment) and consequently high temporal efficiency.

As an example of this benefit, consider an OCU connected to an OLT via 20 km of digital fiber, having one-way propagation time of ˜100 μs=20 km÷{c÷1.48}. The OCU interfaces to a passive coax segment of several hundred meters in length, having one-way propagation time of (for example) 2 μs=500 m÷{c×0.83}. Coax plants often exhibit multipath propagation, making the coax channel somewhat time-dispersive, so the IPG may include allowance for any such echoes on the coax channel to quiesce after intended reception(s). Such echoes commonly decay sufficiently in less than a couple microseconds. The IPG may also include a few microseconds to allow destination TDD transceiver implementation(s) to switch between from receive to transmit mode. Using the claimed invention to accomplish TDD over the entire domain, including the digital fiber, would require an IPG duration of approximately ˜107 μs (e.g., 100+2+2+3). Two such IPGs would be used for each TDD Cycle (one between the US-to-DS transition, and another between the DS-to-US transition). TDD Cycle periods are adjustable, but for this example we can consider a TDD Cycle period, for example of 500 μs. The consequent temporal efficiency of the TDD duplexing would be only 57% because the IPG overhead amounts to 43% ({107 μs+107 μs}÷500 μs). However, using the claimed invention to accomplish TDD while confining the TDD domain to only the passive coax segment, leaving the digital fiber to operate full-duplex, then the IPG duration need not include any (100 μs) contribution from the digital fiber segment, allowing the IPG to be kept as short as 7 μs. In this embodiment, the claimed invention greatly improves the temporal efficiency to 97% because the IPG overhead now amounts to only 3% ({7 μs+7 μs}÷500 μs).

The explanatory depiction (above) of two separate IPGs per TDD Cycle (one between the US-to-DS transition, and another between the DS-to-US transition) is a matter of perspective. Alternate explanations of TDD duplexing overhead could be depicted from some other perspective, such as that from a CLT or OCU. In that alternate explanation, the CLT or OCU would launch its DS traffic, then wait for the downstream propagation, then wait for quiescence at the destination, then wait for the destination CNUs to switch their TDD transceiver implementations from receive mode to transmit mode before launching their upstream traffic, then wait for upstream traffic to propagate towards the CLT or OCU. After receiving that US traffic, the CLT or OCU could almost immediately begin transmitting DS traffic (perhaps after waiting for its TDD transceiver to switch modes, but NOT having to wait for any propagation time). From such perspective, the TDD duplexing overhead could be depicted as a single IPG, but having twice the duration (i.e., including both a DS propagation time plus an US propagation time). It will be obvious to someone skilled in the art that such alternate explanations of TDD duplexing overheads are equivalent, resulting in the same temporal efficiency, and that the claimed invention and its benefits apply congruently to any such alternate depictions or perspectives.

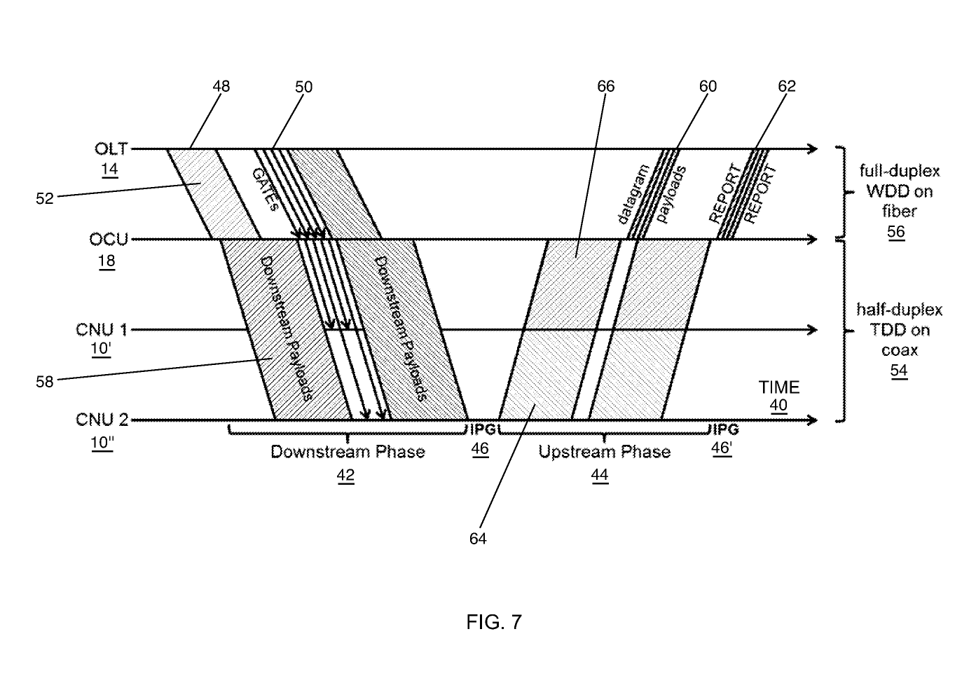

As an example, FIG. 7 depicts TDD traffic on an EPoC network according to the presently claimed invention. The vertical dimension on the diagram represents the effective distance (not necessarily to scale) between various network components, such as OLT 14, OCU 18, and two CNUs 10: CNU1 10′ & CNU2 10″ in this example. The horizontal dimension of the diagram represents time 40, depicting overall a time period slightly larger than one TDD Cycle (i.e., slightly larger than one DS phase 42, plus one US phase 44, plus IPGs 46 between phases). OLT 14 transmits downstream traffic over fiber 56 to OCU 18 using the wavelength dedicated for DS traffic 48. DS traffic 48 includes a variety of messages, including relatively large message payloads, as well as relatively short GATE grant messages 50. FIG. 7 depicts this traffic travelling from OLT 14 to OCU 18 at the propagation velocity over fiber (e.g., c÷1.48, where 1.48 is a common index of refraction for fiber-optic cables, and c is the speed of light). This propagation velocity is represented on the diagram as a slope 52 between OLT 14 and OCU 18. The TDD domain is a half-duplex passive coax segment 54, or a coax cascade, or an HFC cascade, but does NOT include the full-duplex digital fiber 56. Thus, OLT 14 may begin transmitting DS traffic 48 before downstream phase 42 begins on the TDD domain, such that DS 48 traffic begins arriving at OCU 18 just-in-time for the beginning of downstream phase 42. OCU 18 receives DS traffic 48, performs some minimal processing in preparation to relay DS traffic 48 onto RF coax. Such processing by OC18 may include selecting a subset of particular DS payloads 48 according to LLID or some other criteria for nearly realtime relay onto RF coax. DS payloads 48 propagate over coax to, and may be received by, both CNUs 10. FIG. 7 also depicts downstream GATE messages 50 that may be destined for particular CNUs 10. The propagation velocity over coax (e.g., c×83%) is typically faster than over fiber, so the coax slope 58 is depicted as steeper on the coax segments, for both DS 42 and US 44 propagation. OLT 14 schedules DS traffic such that the downstream payloads 48 and GATEs 50 reach the most distant CNU (e.g., CNU2 10″ in this depiction) and are completely received before the end of downstream phase 42.

Still referring to FIG. 7, OLT 14 schedules an IPG 46 between the end of downstream phase 42 and the start of subsequent upstream phase 44.

As shown in FIG. 7, during upstream phase 44, CNUs 10 transmit their pending upstream traffic over RF coax 54 according to GATE-specified grants 50 received from OLT 14 during previous DS phases 42. GATE-specified grants 50 for US CNU transmissions are specifically scheduled by OLT 14 to occur only during US phases 44, to avoid collisions on the coax. The US traffic may include upstream payloads 60 and REPORTs 62, which reach OCU 18 and are completely received before the end of upstream phase 44. FIG. 7 depicts REPORT messages 62 being scheduled late during US phase 44, which provides the most current queue status for the OLT scheduler to process into subsequent GATE to be transmitted downstream during the subsequent DS phase (not shown), thereby facilitating low-latency QoS. FIG. 7 depicts OFDMA US traffic, where more distant CNU2 10″ is scheduled to transmit (the single-hatched traffic 64) before CNU1 10′, then CNU1 transmits coincidently with the passing of CNU2's transmission. OFDMA is depicted for US traffic on coax, but OFDMA may also be used for DS traffic on coax, or both, or not at all. OCU 18 observes an apparently simultaneous reception (the cross-hatched traffic 66) from both CNUs 10, and OCU 18 demultiplexes these apparently simultaneous coax receptions into individual US transmissions 60, 62 for near realtime relay as TDMA traffic to OLT 14 via digital fiber 56.

Still referring to FIG. 7, OLT 14 schedules an IPG 46′ between the end of upstream phase 44 and the start of the subsequent downstream phase (not shown). TDD operation is cyclical, with alternating US 44 and DS phases 42 and intervening IPGs 46. This half-duplex TDD cyclicism need be imposed by the OLT scheduler only on the coax segments, because the digital fiber can be operated as full-duplex WDD where US and DS traffic may pass each other without collision. Thus, IPG overhead can be kept short by not including any time allocation for propagation over lengthy digital fiber. Consequently, some US traffic on digital fiber 56, such as the set of REPORTs 62 60, is depicted as occurring after and outside US phase 44. Similarly, OLT's 14 earliest DS traffic was depicted as launched before and outside DS phase 42.

Another specific benefit of the claimed invention allows the OLT or CLT to schedule the TDD traffic on each passive coax segment independently. That is, each serviced passive coax segment and its CNUs form an independent scheduling domain, where traffic on one coax segment can be scheduled simultaneously with traffic on another coax segment without collision between the segments. Such independent scheduling domains would, for example, enable for each domain: differing TDD Cycle periods or duty cycles, differing IPG duration optimizations, differing modulation types or modulation orders, and/or differing spectral allocations or channel-widths. This enables MSOs to reuse the same EPoC RF spectrum (e.g., the RF spectrum above MSOs' existing CATV services, say from 860 MHz to 1.2 GHz) for each passive coax segment serviced. This spectral reuse multiplies the EPoC throughput capacity which now scales with the number of coax segments serviced, compared to alternative FDD approaches or other TDD architectures that establish a shared scheduling domain spanning the length of a coax or HFC cascade and all the CNUs on that cascade. That is, the full TDD coax datarate gets shared among a smaller number of CNU(s) that are located on, and share a passive coax segment (e.g., a passive coax segment might pass by premises of only ⅕^{th} as many subscribers as a Node+5 coax cascade might pass), such that each CNU has access to a larger fraction of the shared throughput available.

While various embodiments of the disclosed method and apparatus have been described above, it should be understood that they have been presented by way of example only, and should not limit the claimed invention. Likewise, the various diagrams may depict an example architectural or other configuration for the disclosed method and apparatus. This is done to aid in understanding the features and functionality that can be included in the disclosed method and apparatus. The claimed invention is not restricted to the illustrated example architectures or configurations, rather the desired features can be implemented using a variety of alternative architectures and configurations. Indeed, it will be apparent to one of skill in the art how alternative functional, logical or physical partitioning and configurations can be implemented to implement the desired features of the disclosed method and apparatus. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed method and apparatus is described above in terms of various exemplary embodiments and implementations, it should be understood that the various features, aspects and functionality described in one or more of the individual embodiments are not limited in their applicability to the particular embodiment with which they are described. Thus, the breadth and scope of the claimed invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method for implementing Time-Division Duplex (TDD) in an Ethernet Passive Optical Network (EPON), comprising:
a) segregating a US traffic stream (upstream traffic stream) and a DS traffic stream (downstream traffic stream);
b) aggregating the DS traffic stream into first periodic intervals;
c) aggregating the US traffic stream into second periodic intervals; and
d) segregating and interleaving the first periodic intervals and the second periodic intervals.

2. The method of claim 1 wherein the segregating, aggregating, and segregating and interleaving comprise scheduling by an Optical Line Terminal (OLT) scheduler.

3. The method of claim 1 further comprising scheduling REPORTs near an end of US phases.

4. The method of claim 1 wherein segregating and interleaving comprises allowing non-overlapping phases for the US traffic stream and the DS traffic stream.

5. The method of claim 1 wherein segregating and interleaving comprises providing an Inter-Phase Gap (IPG) between TDD phases.

6. The method of claim 1 wherein the US traffic stream and the DS traffic stream comprise a same wavelength.

7. The method of claim 1 wherein the method is performed over a coax (EPoC) network.

8. The method of claim 1 wherein the method is performed in a hybrid EPoC network.

9. A system for implementing Time-Division Duplex (TDD) in an Ethernet Passive Optical Network (EPON) comprising:
means for segregating a US traffic stream (upstream traffic stream) and a DS traffic stream (downstream traffic stream);
means for aggregating the DS traffic stream into first periodic intervals;
means for aggregating the US traffic stream into second periodic intervals; and
means for interleaving the first periodic intervals and the second periodic intervals.

10. The system of claim 9 further comprising an Optical Line Terminal (OLT) scheduler.

11. The system of claim 9 further comprising means for scheduling REPORTs near an end of US phases.

12. The system of claim 9 wherein the US traffic stream and the DS traffic stream have non-overlapping phases.

13. The system of claim 9 further comprising means for providing an Inter-Phase Gap (IPG) between TDD phases.

14. The system of claim 9 wherein the US traffic stream and the DS traffic stream have a same wavelength.

15. The system of claim 9 wherein the Ethernet Passive Optical Network (EPON) is implemented over a coax (EPoC) network.

16. The system of claim 9 wherein the Ethernet Passive Optical Network (EPON) is implemented over a hybrid EPoC network.

17. The system of claim 16 further comprising means for coupling and relaying the US traffic stream and the DS traffic stream between a digital fiber and a coax by at least one OCU (Optical-Coax Unit).

18. The system of claim 17 wherein the coax comprises at least one CNU residing on a member from a group consisting of a passive coax segment, multiple passive coax segments, an active coax leg, multiple active coax legs, and a Hybrid Fiber and Coaxial (HFC) plant.

19. The system of claim 18 wherein a PHYsical-layer for the at least one CNU is substantially the same as a PHYsical-layer for Frequency-Division Duplex (FDD) EPoC CNUs with upstream and downstream RF channels tuned to overlap.

20. The system of claim 17 wherein the US traffic stream and the DS traffic stream on the digital fiber are scheduled to overlap.

21. The system of claim 19 further comprising a means for providing a filter before an amplifier located downstream of the at least one OCU.

22. A non-transitory computer-executable storage medium including program instructions which are computer-executable to implement Time-Division Duplex (TDD) in an Ethernet Passive Optical Network (EPON), the program instructions comprising:
program instructions that cause a segregation of a US traffic stream (upstream traffic stream) and a DS traffic stream (downstream traffic stream);
program instructions that cause an aggregation the DS traffic stream into first periodic intervals;
program instructions that cause an aggregation of the US traffic stream into second periodic intervals; and
program instructions that cause a segregation and interleaving of the first periodic intervals and the second periodic intervals.

23. The non-transitory computer-executable storage medium of claim 22 wherein the program instructions implement an optical line terminal (OLT) scheduler.

24. The non-transitory computer-executable storage medium of claim 22 further comprising program instructions that cause a schedule of REPORTs near an end of US phases.

25. The non-transitory computer-executable storage medium of claim 22 wherein the program instructions produce non-overlapping phases for the US traffic stream and the DS traffic stream.

26. The non-transitory computer-executable storage medium of claim 22 wherein the program instructions provide an inter-phase gap (IPG) between TDD phases.

27. The non-transitory computer-executable storage medium of claim 22 wherein the US traffic stream and the DS traffic stream have a same wavelength.

28. The non-transitory computer-executable storage medium of claim 22 wherein the program instructions which are computer-executable to implement the Ethernet Passive Optical Network (EPON) over a coax (EPoC) network.

29. The non-transitory computer-executable storage medium of claim 28 wherein the coax (EPoC) network is a hybrid EPoC network.
